(19) United States
(12) Patent Application Publication
(10) Pub. No.: US 2024/0112384 A1
(43) Pub. Date: Apr. 4, 2024

(54) INFORMATION PROCESSING APPARATUS, INFORMATION PROCESSING METHOD, AND PROGRAM

(71) Applicant: NIPPON TELEGRAPH AND TELEPHONE CORPORATION, Tokyo (JP)

(72) Inventors: Shota YAMADA, Musashino-shi, Tokyo (JP); Hirokazu KAKINUMA, Musashino-shi, Tokyo (JP); Hidenobu NAGATA, Musashino-shi, Tokyo (JP)

(73) Assignee: NIPPON TELEGRAPH AND TELEPHONE CORPORATION, Tokyo (JP)

(21) Appl. No.: 18/285,390

(22) PCT Filed: Apr. 6, 2021
(86) PCT No.: PCT/JP2021/014620

§ 371 Date: Oct. 3, 2023

(51) Int. Cl. G06T 11/60; G06T 3/40; G06V 10/44; G06V 10/60

(52) U.S. Cl. CPC G06T 11/60; G06T 3/40; G06V 10/44; G06V 10/60

(57) ABSTRACT

An information processing device includes an extraction unit, an inverse sampling unit, a mapping unit, a generation unit, and a correction unit. The extraction unit is to extract a first feature value of a first image. The inverse sampling unit is to generate a second image having a resolution lower than that of the first image based on the first image and first information indicating a lighting environment different from that of the first image. The mapping unit generates a vector representing a latent space based on the second image. The generation unit is configured to generate a second feature value of a third image having a resolution higher than that of the second image based on the vector. The correction unit is configured to generate a fourth image obtained by correcting the third image based on the first feature value and the second feature value.

### TECHNICAL FIELD

The present embodiment relates to an information processing device, an information processing method, and a program.

### BACKGROUND ART

There is a well-known technology for generating an image (relit image), based on an input image, to which a lighting environment different from that of the input image is applied. Such a technology is called “relighting.”

Deep-learning-based relighting is generally implemented by direct estimation or inverse rendering. Direct estimation is a method for generating a relit image based on an input image and a desired lighting environment, without estimating a 3D shape and reflectance of a subject in the input image. Meanwhile, inverse rendering estimates, based on an input image, a 3D shape and reflectance of a subject in the input image. A relit image is generated by rendering the image to a desired lighting environment based on the estimated 3D shape and reflectance.

### CITATION LIST

### Non Patent Literature

Non Patent Literature 1: T. SUN, et al., “Single Image Portrait Relighting”, SIGGRAPH, 2019
Non Patent Literature 2: S. Sengupta, et al., “SfSNet: Learning, Reflectance and Illuminance of Faces in the Wild”, CVPR, 2018
Non Patent Literature 3: E. Richardson, et al., “Encoding in Style: a StyleGAN Encoder for Image-to-Image Translation”, arxiv, 2008:00951

### SUMMARY OF INVENTION

### Technical Problem

However, direction estimation is likely to generate a relit image deviating from physical properties of the object in the input image since it does not estimate the 3D shape and reflectance of the object. On the other hand, inverse rendering is likely to deteriorate image quality of the relit image due to errors in the estimated 3D shape and reflectance. Furthermore, inverse rendering is heavy-load processing and takes a longer time than direct estimation.

The present invention has been made to solve such problems stated above, and an object thereof is to provide a technology for generating a high-quality relit image while suppressing processing load.

### Solution to Problem

An information processing device according to one aspect includes an extraction unit, an inverse rendering unit, a mapping unit, a generation unit, and a correction unit. The extraction unit is configured to extract a first feature value of a first image. The inverse rendering unit is configured to generate a second image having a resolution lower than that of the first image based on the first image and first information indicating a lighting environment different from that of the first image. The mapping unit is configured to generate a vector representing a latent space based on the second image. The generation unit is configured to generate a second feature value of a third image having a resolution higher than that of the second image based on the vector. The correction unit is configured to generate a fourth image obtained by correcting the third image based on the first feature value and the second feature value.

### Advantageous Effects of Invention

According to the embodiment, it is possible to provide a technology for generating a high-quality relit image while suppressing a processing load.

### BRIEF DESCRIPTION OF DRAWINGS

FIG. 1 is a block diagram illustrating one example of a configuration of an information processing system according to an embodiment.

FIG. 2 is a block diagram illustrating one example of a hardware configuration of a storage device according to the embodiment.

FIG. 3 is a block diagram illustrating one example of a hardware configuration of an information processing device according to the embodiment.

FIG. 4 is a block diagram illustrating one example of a configuration of a learning function of the information processing system according to the embodiment.

FIG. 5 is a block diagram illustrating one example of a configuration of a learning function of an inverse rendering unit according to the embodiment.

FIG. 6 is a block diagram illustrating one example of a configuration of an image generation function of the information processing system according to the embodiment.

FIG. 7 is a block diagram illustrating one example of a configuration of an image generation function of the inverse rendering unit according to the embodiment.

FIG. 8 is a flowchart illustrating one example of a series of operations including a learning operation in the information processing system according to the embodiment.

FIG. 9 is a flowchart illustrating one example of a learning operation in the information processing device according to the embodiment.

FIG. 10 is a flowchart illustrating one example of an image generation operation in the information processing device according to the embodiment.

### DESCRIPTION OF EMBODIMENTS

Hereinafter, an embodiment will be described with reference to the drawings. In the following description, components having the same function and configuration are denoted by the same reference numerals.

### 1. Embodiment

### 1.1 Overall Configuration

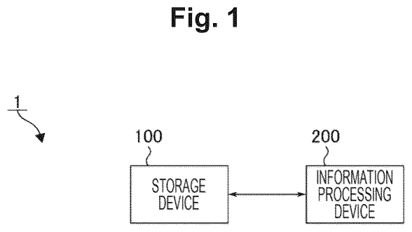

A configuration of an information processing system according to the embodiment will be described hereinbelow. FIG. 1 is a block diagram illustrating one example of a configuration of the information processing system according to the embodiment.

As illustrated in FIG. 1, an information processing system 1 is a computer network in which a plurality of computers are connected. The information processing system 1 includes a storage device 100 and an information processing device 200 connected to each other.

The storage device 100 is, for example, a data server. The storage device 100 stores data used for various operations in the information processing device 200.

The information processing device 200 is, for example, a terminal. The information processing device 200 executes various operations based on the data from the storage device 100. The various operations in the information processing device 200 include, for example, a learning operation and an image generation operation. The learning operation and the image generation operation will be described in detail later.

### 1.2 Hardware Configuration

A hardware configuration of the information processing system according to the embodiment will be described hereinbelow.

### 1.2.1 Storage Device

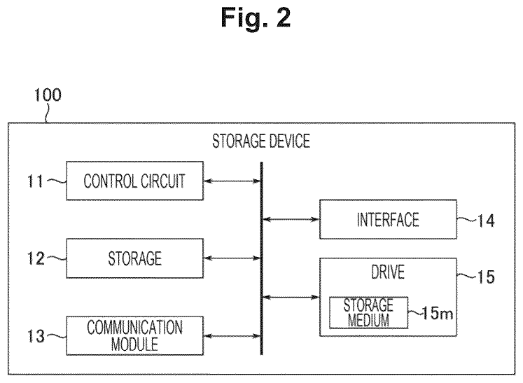

FIG. 2 is a block diagram illustrating one example of a hardware configuration of the storage device according to the embodiment. As illustrated in FIG. 2, the storage device 100 includes a control circuit 11, a storage 12, a communication module 13, an interface 14, a drive 15, and a storage medium 15m.

The control circuit 11 is a circuit that performs overall control on each component of the storage device 100. The control circuit 11 includes, for example, a central processing unit (CPU), a random access memory (RAM), and a read only memory (ROM).

The storage 12 is an auxiliary storage device of the storage device 10. The storage 12 is, for example, a hard disk drive (HDD), a solid state drive (SSD), or a memory card. The storage 12 stores data used for the learning operation and the image generation operation. Moreover, the storage 12 may store a program for executing a process related to the storage device 100 in a series of processing including the learning operation and the image generation operation.

The communication module 13 is a circuit used to exchange data with the information processing device 200.

The interface 14 is a circuit for communicating information between a user and the control circuit 11. The interface 14 includes an input device and an output device. The input device includes, for example, a touchscreen and operation buttons. The output device includes, for example, a liquid crystal display (LCD) or an electroluminescence (EL) display, and a printer. The interface 14 converts a user input into an electrical signal, and then transmits the electrical signal to the control circuit 11. The interface 14 outputs execution results based on the user input to the user.

The drive 15 is a device for reading software stored in the storage medium 15m. The drive 15 includes, for example, a compact disk (CD) drive and a digital versatile disk (DVD) drive.

The storage medium 15m is a medium that stores software by electrical, magnetic, optical, mechanical, or chemical action. Moreover, the storage medium 15m may store a program for executing a process related to the storage device 100 in a series of processing including the learning operation and the image generation operation.

### 1.2.2 Information Processing Device

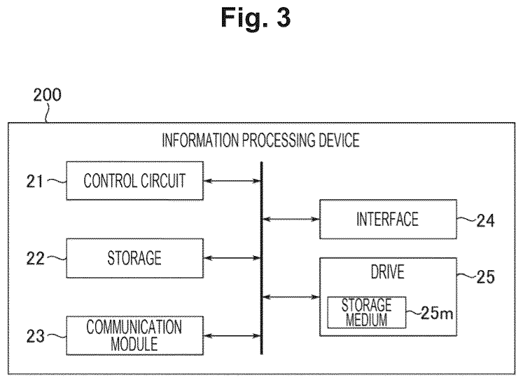

FIG. 3 is a block diagram illustrating one example of a hardware configuration of the information processing device according to the embodiment. As illustrated in FIG. 3, the information processing device 200 includes a control circuit 21, a storage 22, a communication module 23, an interface 24, a drive 25, and a storage medium 25m.

The control circuit 21 is a circuit that performs overall control on each component of the information processing device 200. The control circuit 21 includes, for example, a CPU, a RAM, and a ROM.

The storage 22 is an auxiliary storage device of the information processing device 20. The storage 22 is, for example, an HDD, an SSD, or a memory card. The storage 22 stores execution results of the learning operation and the image generation operation. Moreover, the storage 22 may store a program for executing a process related to the information processing device 200 in a series of processing including the learning operation and the image generation operation.

The communication module 23 is a circuit used to exchange data with the storage device 100.

The interface 24 is a circuit for communicating information between a user and the control circuit 21. The interface 24 includes an input device and an output device. The input device includes, for example, a touchscreen and operation buttons. The output device includes, for example, an LCD or an EL display, and a printer. The interface 24 converts a user input into an electrical signal, and then transmits the electrical signal to the control circuit 21. The interface 24 outputs execution results based on the user input to the user.

The drive 25 is a device for reading software stored in the storage medium 25m. The drive 25 includes, for example, a CD drive and a DVD drive.

The storage medium 25m is a medium that stores software by electrical, magnetic, optical, mechanical, or chemical action. Moreover, the storage medium 25m may store a program for executing a process related to the information processing device 200 in a series of processing including the learning operation and the image generation operation.

### 1.3 Functional Configuration

A functional configuration of an information processing system according to the embodiment will be described hereinbelow.

### 1.3.1 Learning Function

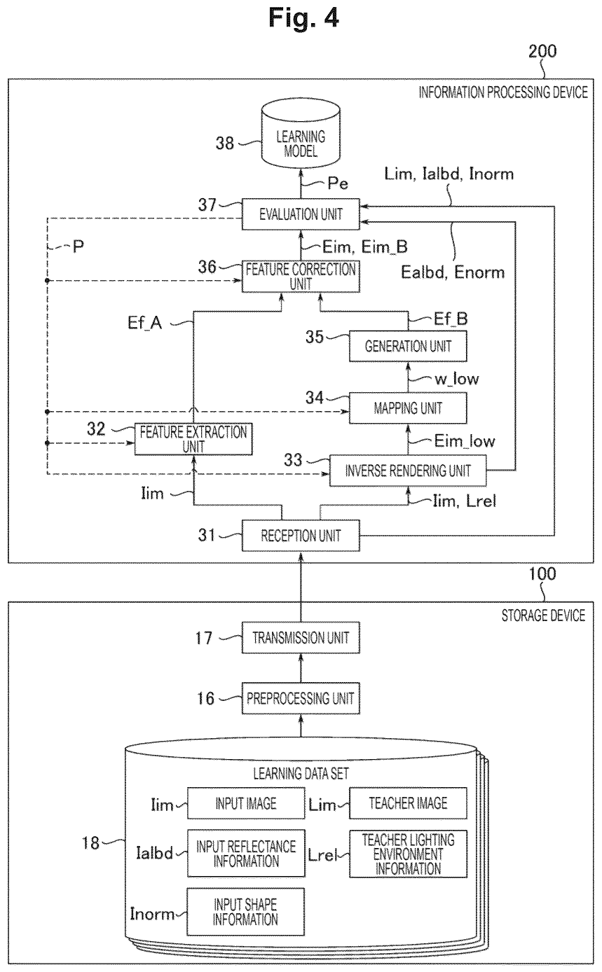

A configuration of a learning function of the information processing system according to the embodiment will be described. FIG. 4 is a block diagram illustrating one example of a configuration of the learning function of the information processing system according to the embodiment.

### (Configuration of Learning Function of Storage Device)

The CPU of the control circuit 11 deploys a learning operation program stored in the storage 12 or the storage medium 15m into the RAM. The CPU of the control circuit 11 interprets and executes the program deployed in the RAM. Accordingly, the storage device 100 serves as a computer including a preprocessing unit 16 and a transmission unit 17. The storage 12 stores a plurality of learning data sets 18.

The plurality of learning data sets 18 are a cluster of data sets used for a single learning operation. In other words, each of the learning data sets 18 is a unit of data sets used for a single learning operation. Each of the learning data sets 18 includes an input image Iim, input reflectance information Ialbd, input shape information Inorm, a teacher image Lim, and teacher lighting environment information Lrel.

The input image Iim is an image to be subjected to a relighting process.

The input reflectance information Ialbd is data indicating a reflectance of a subject in the input image Iim. The input reflectance information Ialbd is, for example, an image on which a reflectance vector of the subject in the input image Iim is mapped.

The input shape information Inorm is data indicating a 3D shape of the subject in the input image Iim. The input shape information Inorm is, for example, an image on which a normal vector of the subject in the input image Iim is mapped.

The teacher image Lim is an image in which a lighting environment different from that of the input image Iim is applied to the same subject as the input image Iim. That is, the teacher image Lim is a true image after the relighting process is executed on the input image Iim.

The teacher lighting environment information Lrel is data indicating the lighting environment of the teacher image Lim. The teacher lighting environment information Lrel is, for example, a vector using a spherical harmonic function.

The preprocessing unit 16 performs preprocessing on the learning data sets 18 into a format used for the learning operation. The preprocessing unit 16 transmits the preprocessed learning data sets 18 to the transmission unit 17.

The transmission unit 17 transmits the preprocessed learning data sets 18 to the information processing device 200.

Hereinafter, for convenience, the preprocessed learning data sets 18 are simply referred to as the “learning data sets 18.”

### (Configuration of Learning Function of Information Processing Device)

The CPU of the control circuit 21 deploys a learning operation program stored in the storage 22 or the storage medium 25m into the RAM. The CPU of the control circuit 21 interprets and executes the program deployed in the RAM. Accordingly, the information processing device 200 serves as a computer including a reception unit 31, a feature extraction unit 32, an inverse rendering unit 33, a mapping unit 34, a generation unit 35, a feature correction unit 36, and an evaluation unit 37. The storage 22 stores a learning model 38.

The reception unit 31 receives the learning data sets 18 from the transmission unit 17 of the storage device 100. The reception unit 31 transmits each learning data set used for a single learning operation to each unit in the information processing device 200 out of the learning data sets 18. Specifically, the reception unit 31 transmits the input image Iim to the feature extraction unit 32. The reception unit 31 transmits the input image Iim and the teacher lighting environment information Lrel to the inverse rendering unit 33. The reception unit 31 transmits the teacher image Lim, the input reflectance information Ialbd, and the input shape information Inorm to the evaluation unit 37.

The feature extraction unit 32 includes an encoder. The encoder in the feature extraction unit 32 has a plurality of layers connected in series. Each of the layers in the feature extraction unit 32 includes a deep learning sublayer. The deep learning sublayer includes a multi-layered neural network. The number N of layers of the encoder in the feature extraction unit 32 can be designed as the user wants (N is an integer of 2 or more). The feature extraction unit 32 encodes the input image Iim to extract a feature value of the input image Iim for each of layers. In particular, a first layer of the encoder in the feature extraction unit 32 generates a feature value Ef_A(1) based on the input image Iim. A resolution of the feature value Ef_A(1) is ½ of a resolution of the input image Iim. An n-th layer of the encoder in the feature extraction unit 32 generates a feature value Ef_A(n) based on a feature value Ef_A(n−1) (2≤n≤N). A resolution of the feature value Ef_A(n) is ½ of a resolution of the feature value Ef_A(n−1). For the feature values Ef_A(1) to Ef_A(N), a feature value corresponding to a layer in the later order has a lower resolution. The feature extraction unit 32 transmits the feature values Ef_A(1) to Ef_A(N) to the feature correction unit 36 as a feature value group Ef_A.

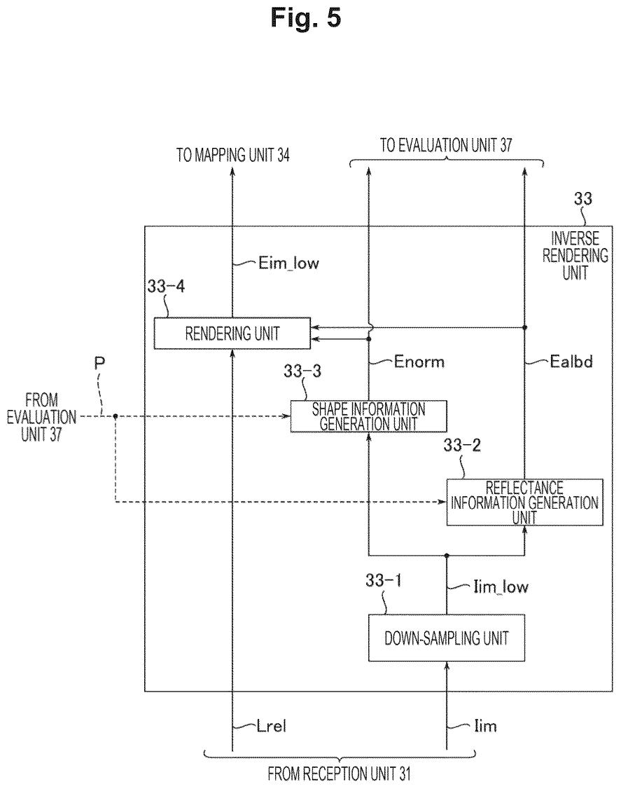

FIG. 5 is a block diagram illustrating one example of a configuration of a learning function of the inverse rendering unit according to the embodiment. As illustrated in FIG. 5, the inverse rendering unit 33 includes a down-sampling unit 33-1, a reflectance information generation unit 33-2, a shape information generation unit 33-3, and a rendering unit 33-4.

The down-sampling unit 33-1 includes a down-sampler. The down-sampling unit 33-1 receives the input image Iim from the reception unit 31. The down-sampling unit 33-1 down-samples the input image Iim. The down-sampling unit 33-1 may filter an image with reduced resolution by a Gaussian filter. The down-sampling unit 33-1 transmits a generated image as a low-resolution input image Iim_low to the reflectance information generation unit 33-2 and the shape information generation unit 33-3.

The reflectance information generation unit 33-2 includes an encoder and a decoder. Each of the encoder and the decoder in the reflectance information generation unit 33-2 has a plurality of layers connected in series. Each of the layers in the reflectance information generation unit 33-2 includes a deep learning sublayer. The number of layers of the encoder and the encoding process, and the number of layers of the decoder and the decoding process in the reflectance information generation unit 33-2 can be designed as the user wants. The reflectance information generation unit 33-2 generates estimated reflectance information Ealbd based on the low-resolution input image Iim_low. The estimated reflectance information Ealbd is an estimated value of information indicating a reflectance of the subject in the low-resolution input image Iim_low. The estimated reflectance information Ealbd is, for example, an image on which a reflectance vector of the subject in the low-resolution input image Iim_low is mapped. The reflectance information generation unit 33-2 transmits the estimated reflectance information Ealbd to the rendering unit 33-4 and the evaluation unit 37.

The shape information generation unit 33-3 includes an encoder and a decoder. Each of the encoder and the decoder in the shape information generation unit 33-3 has a plurality of layers connected in series. Each of the layers in the shape information generation unit 33-3 includes a deep learning sublayer. The number of layers of the encoder and the encoding process, and the number of layers of the decoder and the decoding process in the shape information generation unit 33-3 can be designed as the user wants. The shape information generation unit 33-3 generates estimated shape information Enorm based on the low-resolution input image Iim_low. The estimated shape information Enorm is an estimated value of information indicating a 3D shape of the subject in the low-resolution input image Iim_low. The estimated shape information Enorm is, for example, an image on which a normal vector of the subject in the low-resolution input image Iim_low is mapped. The shape information generation unit 33-3 transmits the estimated shape information Enorm to the rendering unit 33-4 and the evaluation unit 37.

The rendering unit 33-4 includes a renderer. The rendering unit 33-4 executes a rendering process on the basis of a rendering equation. The rendering unit 33-4 assumes Lambertian reflection in the rendering process. The rendering unit 33-4 further receives the teacher lighting environment information Lrel from the reception unit 31. The rendering unit 33-4 generates a low-resolution relit image Eim_low based on the estimated reflectance information Ealbd, the estimated shape information Enorm, and the teacher lighting environment information Lrel. That is, the low-resolution relit image Eim_low is a low-resolution relit image estimated by applying the teacher lighting environment information Lrel to the low-resolution input image Iim_low. The rendering unit 33-4 transmits the low-resolution relit image Eim_low to the mapping unit 34.

Referring to FIG. 4, a configuration of the learning function of the information processing device 200 will be described.

The mapping unit 34 includes a plurality of encoders. Each of the encoders in the mapping unit 34 generates a plurality of vectors w_low based on the low-resolution relit image Eim_low. Each of the vectors w_low represents a latent space of the generation unit 35. The mapping unit 34 transmits the vectors w_low to the generation unit 35.

The generation unit 35 is an image generation model (generator). The generator in the generation unit 35 has a plurality of layers connected in series. Each of the layers in the generator of the generation unit 35 includes a deep learning sublayer. The number M of layers in the generator of the generation unit 35 is, for example, ½ of the number of encoders in the mapping unit 34 (M is an integer of 2 or more). The number M of layers of the generator in the generation unit 35 may be the same as or different from the number N of layers of the encoder in the feature extraction unit 32. At least one corresponding vector among the vectors w_low is input to (embedded in) each of the layers in the generation unit 35. The generation unit 35 generates a feature value for each of the layers based on the vectors w_low. The generation unit 35 transmits a plurality of feature values respectively corresponding to the plurality of layers to the feature correction unit 36 as a feature value group Ef_B.

A generator that has learned a task (super-resolution task) of generating a high-resolution image from a low-resolution image using a large-scale data set is applied to the generation unit 35. In particular, for example, StyleGAN2 can be applied to the generation unit 35. Therefore, for the feature values in the feature value group Ef_B, a feature value corresponding to a layer in the later order has a higher resolution.

The feature correction unit 36 includes a decoder. The decoder in the feature correction unit 36 has a plurality of layers connected in series. Each of the layers in the feature correction unit 36 includes a deep learning sublayer. The number of layers in the decoder of the feature correction unit 36 is equal to the number N of layers in the feature extraction unit 32, for example. The feature correction unit 36 generates an estimated relit image Eim based on the feature value groups Ef_A and Ef_B.

In particular, the feature correction unit 36 combines a feature value Ef_A(N) having the lowest resolution in the feature value group Ef_A and a feature value (referred to as Ef_B(1)) having the same resolution as the feature value Ef_A(N) in the feature value group Ef_B. A first layer of the decoder in the feature correction unit 36 generates a feature value Ef(1) based on a combination of the feature values Ef_A(N) and Ef_B(1). A resolution of the feature value Ef(1) is twice a resolution of the feature values Ef_A(N) and Ef_B(1).

Moreover, the feature correction unit 36 combines a feature value Ef_A(N−m+1) and a feature value (referred to as Ef_B(m)) having the same resolution as the feature value Ef_A(N−m+1) in the feature value group Ef_B (2≤m≤N). An m-th layer of the decoder in the feature correction unit 36 generates a feature value Ef(m) based on a combination of the feature values Ef_A(N−m+1) and Ef_B(m), as well as a feature value Ef(m−1). A resolution of the feature value Ef(m) is twice a resolution of the feature value Ef(m−1).

The feature correction unit 36 generates the estimated relit image Eim by converting the feature value Ef(N) into the RGB color space. Further, the feature correction unit 36 generates an estimated relit image Eim_B by converting a feature value (for example, a feature value output from the M-th layer of the generation unit 35) having the highest resolution in the feature value group Ef_B into the RGB color space. The feature correction unit 36 transmits the estimated relit images Eim and Eim_B to the evaluation unit 37.

The evaluation unit 37 includes updata. The evaluation unit 37 updates a parameter P so as to minimize respective errors of the estimated relit images Eim and Eim_B for the teacher image Lim, errors of the estimated reflectance information Ealbd for the input reflectance information Ialbd, and errors of the estimated shape information Enorm for the input shape information Inorm. The parameter P is a parameter for determining characteristics of the deep learning sublayer provided in each of the feature extraction unit 32, the reflectance information generation unit 33-2, the shape information generation unit 33-3, the mapping unit 34, and the feature correction unit 36. The parameter P does not include a parameter for determining characteristics of the deep learning sublayer provided in the generation unit 35. When calculating the errors, the evaluation unit 37 applies, for example, an L1 norm or an L2 norm as an error function. In calculating the errors of the estimated relit images Eim and Eim_B for the teacher image Lim, the evaluation unit 37 may further apply an L1 norm or an L2 norm of a feature value calculated by another encoder as an option. Examples of the encoder applied as the option include an encoder (e.g. VGG) used for image classification and an encoder (e.g. ArcFace) used for face recognition and face search. For calculating the parameter P, the evaluation unit 37 uses, for example, error back propagation algorithm.

The evaluation unit 37 stores the parameter P in the storage 22 as a learning model 38 every time an update process using the learning data sets 18 ends (every one epoch).

Hereinafter, the parameter P stored as the learning model 38 is referred to as a parameter Pe to be distinguished from the parameter P in the middle of the epoch.

The learning model 38 is a parameter for determining characteristics of the deep learning sublayer provided in each of the feature extraction unit 32, the reflectance information generation unit 33-2, the shape information generation unit 33-3, the mapping unit 34, and the feature correction unit 36. The learning model 38 includes, for example, the parameter Pe for each epoch.

### 1.3.2 Image Generation Function

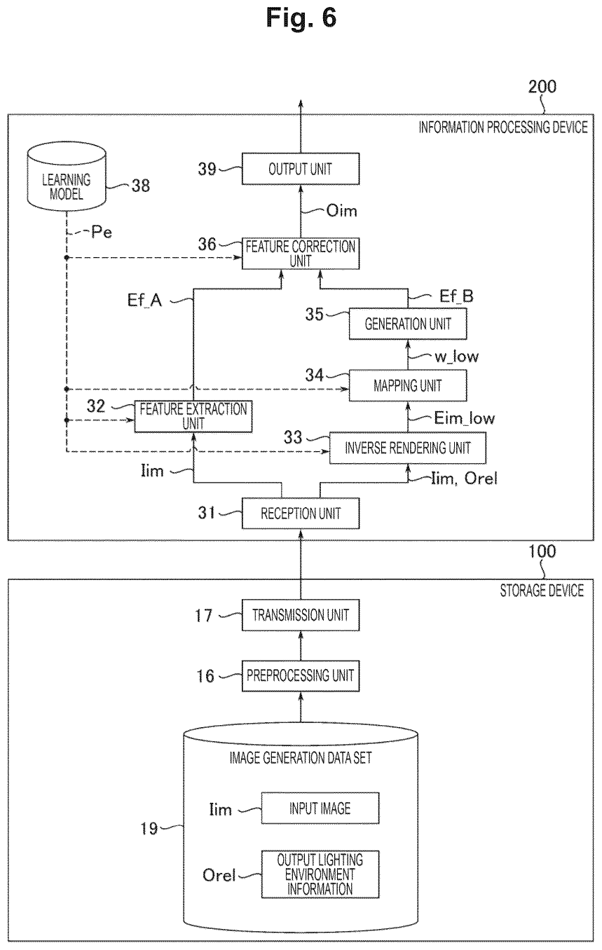

A configuration of an image generation function of the information processing system according to the embodiment will be described hereinbelow. FIG. 6 is a block diagram illustrating one example of a configuration of the image generation function of the information processing system according to the embodiment.

### (Configuration of Image Generation Function of Storage Device)

The CPU of the control circuit 11 deploys an image generation operation program stored in the storage 12 or the storage medium 15m into the RAM. The CPU of the control circuit 11 interprets and executes the program deployed in the RAM. Accordingly, the storage device 100 serves as a computer including a preprocessing unit 16 and a transmission unit 17. The storage 12 stores an image generation data set 19.

The image generation data set 19 is a data set used for an image generation operation. The image generation data set 19 includes the input image Iim and output lighting environment information Orel.

The output lighting environment information Orel is data indicating a lighting environment of an image to be generated by the image generation operation. The output lighting environment information Orel is, for example, a vector using a spherical harmonic function.

The preprocessing unit 16 performs preprocessing on the image generation data set 19 into a format used for the image generation operation. The preprocessing unit 16 transmits the preprocessed image generation data set 19 to the transmission unit 17.

The transmission unit 17 transmits the preprocessed image generation data set 19 to the information processing device 200.

Hereinafter, for convenience, the preprocessed image generation data set 19 is simply referred to as the “image generation data set 19.”

### (Configuration of Image Generation Function of Information Processing Device)

The CPU of the control circuit 21 deploys an image generation operation program stored in the storage 22 or the storage medium 25m into the RAM. The CPU of the control circuit 21 interprets and executes the program deployed in the RAM. Accordingly, the information processing device 200 serves as a computer including the reception unit 31, the feature extraction unit 32, the inverse rendering unit 33, the mapping unit 34, the generation unit 35, the feature correction unit 36, and an output unit 39. The storage 22 stores a learning model 38. The parameter Pe of the final epoch in the learning model 38 is applied to the deep learning sublayer provided in each of the feature extraction unit 32, the reflectance information generation unit 33-2, the shape information generation unit 33-3, the mapping unit 34, and the feature correction unit 36.

The reception unit 31 receives the image generation data set 19 from the transmission unit 17 of the storage device 100. The reception unit 31 transmits the image generation data set 19 to each unit in the information processing device 200 for every learning data set used for a single learning operation. Specifically, the reception unit 31 transmits the input image Iim to the feature extraction unit 32. The reception unit 31 transmits the input image Iim and the output lighting environment information Orel to the inverse rendering unit 33.

Since the configuration of the image generation function of the feature extraction unit 32 is equivalent to the configuration of the learning function of the feature extraction unit 32, the description thereof will be omitted.

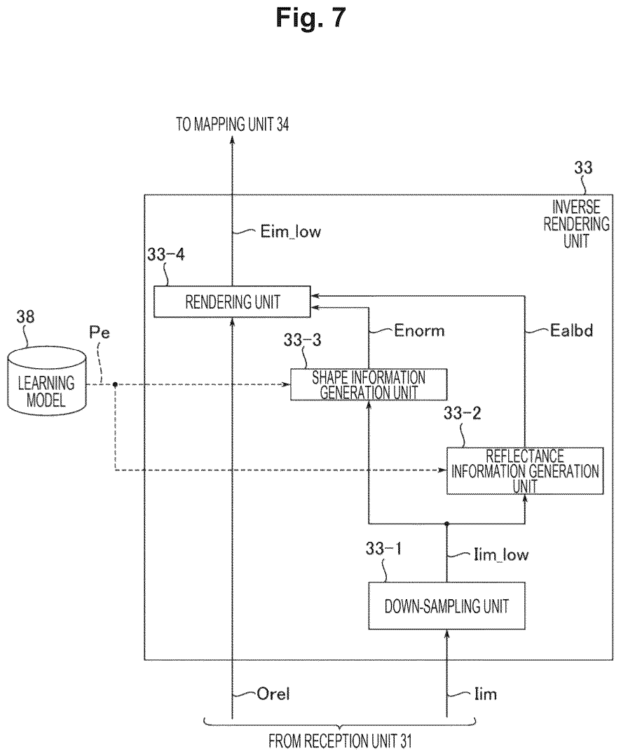

FIG. 7 is a block diagram illustrating one example of a configuration of an image generation function of the inverse rendering unit according to the embodiment.

Since a configuration of an image generation function of the down-sampling unit 33-1 is equivalent to the configuration of the learning function of the down-sampling unit 33-1, the description thereof will be omitted.

The reflectance information generation unit 33-2 generates estimated reflectance information Ealbd based on the low-resolution input image Iim_low. The reflectance information generation unit 33-2 transmits the estimated reflectance information Ealbd to the rendering unit 33-4.

The shape information generation unit 33-3 generates estimated shape information Enorm based on the low-resolution input image Iim_low. The shape information generation unit 33-3 transmits the estimated shape information Enorm to the rendering unit 33-4.

The rendering unit 33-4 further receives the output lighting environment information Orel from the reception unit 31. The rendering unit 33-4 generates a low-resolution relit image Eim_low based on the estimated reflectance information Ealbd, the estimated shape information Enorm, and the output lighting environment information Orel. The rendering unit 33-4 transmits the low-resolution relit image Eim_low to the mapping unit 34.

Referring to FIG. 6, a configuration of the image generation function of the information processing device 200 will be described.

Since configurations of the image generation functions of the mapping unit 34 and the generation unit 35 are equivalent to the configurations of the learning functions of the mapping unit 34 and the generation unit 35, respectively, the descriptions thereof will be omitted.

The feature correction unit 36 generates an output relit image Oim based on the feature value groups Ef_A and Ef_B. The output relit image Oim is generated by a method equivalent to the estimated relit image Eim. The feature correction unit 36 transmits the output relit image Oim to the output unit 39.

The output unit 39 transmits the output relit image Oim to the user.

With the configuration state above, the information processing device 200 can output the output relit image Oim by the image generation function on the basis of the parameter Pe updated by the learning function.

### 1.4 Operations

The operations of the information processing system according to the embodiment will be described hereinbelow.

### 1.4.1 Learning Operation

The learning operation of the information processing system according to the embodiment will be described.

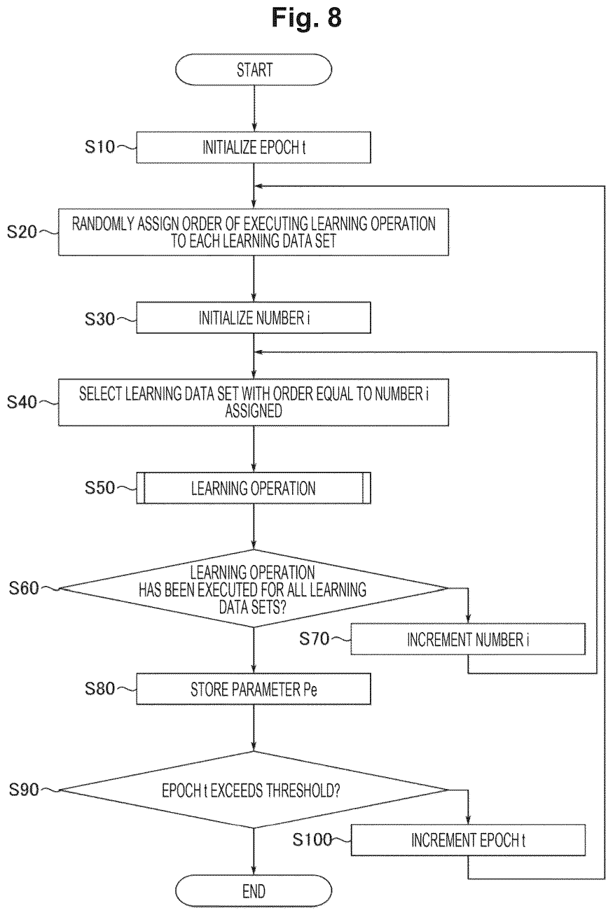

FIG. 8 is a flowchart illustrating one example of a series of operations including the learning operation in the information processing system according to the embodiment.

As illustrated in FIG. 8, when receiving an instruction to execute a series of operations including the learning operation from the user (Start), the control circuit 11 of the storage device 100 initializes an epoch t (S10).

The control circuit 11 of the storage device 100 randomly assigns an order in which the learning operation is executed to each of the learning data sets 18 (S20).

The control circuit 11 of the storage device 100 initializes the number i (S30).

The control circuit 11 of the storage device 100 selects a learning data set to which the order equal to the number i is assigned among the learning data sets 18 (S40). Specifically, the preprocessing unit 16 executes preprocessing on the selected learning data set. The transmission unit 17 transmits the preprocessed learning data set to the information processing device 200.

The control circuit 21 of the information processing device 200 executes the learning operation on the learning data set selected in S40 (S50). The learning operation will be described in detail later.

The control circuit 11 of the storage device 100 determines whether the learning operation has been executed for all of the learning data sets 18 based on the order assigned in S20 (S60).

In a case where the learning operation is not executed for all of the learning data sets 18 (NO in S60), the control circuit 11 of the storage device 100 increments the number i (S70). After S70, the control circuit 11 of the storage device 100 selects a learning data set to which the order equal to the number i incremented in S70 is assigned (S40). The processing between S40 to S70 is repeatedly executed until the learning operation is executed for all of the learning data sets 18.

In a case where the learning operation is executed for all of the learning data sets 18 (YES in S60), the control circuit 21 of the information processing device 200 stores the parameter Pe in the storage 22 as the learning model 38 (S80). The control circuit 21 of the information processing device 200 can execute the processing of S80 based on an instruction from the control circuit 11 of the storage device 100.

After S80, the control circuit 11 of the storage device 100 determines whether the epoch t exceeds a threshold (S90).

In a case where the epoch t does not exceed the threshold (NO in S90), the control circuit 11 of the storage device 100 increments the epoch t (S100). After S100, the control circuit 11 of the storage device 100 randomly assigns an order in which the learning operation is executed to each of the learning data sets 18 (S20). In other words, the execution order of the learning operation in the epoch incremented in S100 is randomly changed. Consequently, the learning operation on the learning data sets 18 of which the execution order is changed for each epoch is repeatedly executed until the epoch t exceeds the threshold.

In a case where the epoch t exceeds the threshold (YES in S90), a series of operations including the learning operation ends (End).

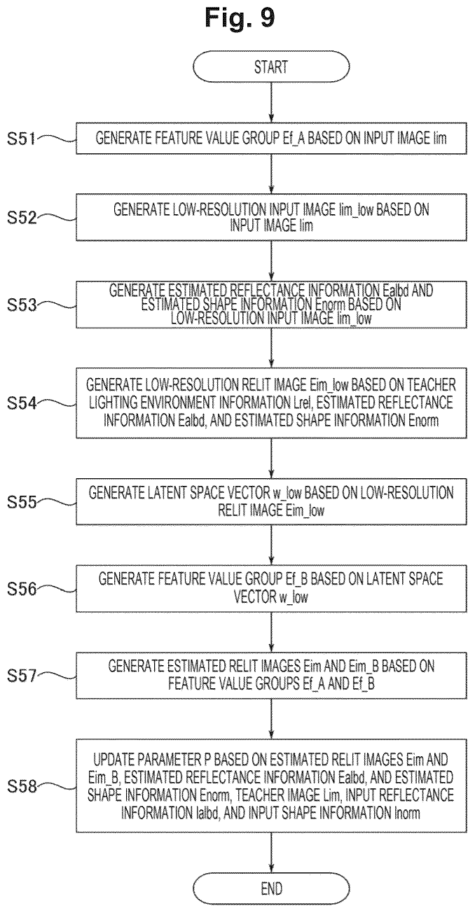

FIG. 9 is a flowchart illustrating one example of the learning operation in the information processing device according to the embodiment. In FIG. 9, the processing between S51 and S58 is illustrated as details of the processing of S50 illustrated in FIG. 8.

When the learning data set selected in S40 is received from the transmission unit 17 (Start), the reception unit 31 transmits the input image Iim to the feature extraction unit 32 and the down-sampling unit 33-1. The reception unit 31 transmits the teacher lighting environment information Lrel to the rendering unit 33-4. The reception unit 31 transmits the teacher image Lim, the input reflectance information Ialbd, and the input shape information Inorm to the evaluation unit 37.

The feature extraction unit 32 generates the feature value group Ef_A based on the input image Iim (S51). The feature extraction unit 32 transmits the generated feature value group Ef_A to the feature correction unit 36.

The down-sampling unit 33-1 generates the low-resolution input image Iim_low based on the input image Iim (S52). The down-sampling unit 33-1 transmits the generated low-resolution input image Iim_low to the reflectance information generation unit 33-2 and the shape information generation unit 33-3.

The reflectance information generation unit 33-2 and the shape information generation unit 33-3 generate the estimated reflectance information Ealbd and the estimated shape information Enorm, respectively, based on the low-resolution input image Iim_low (S53). The reflectance information generation unit 33-2 transmits the generated estimated reflectance information Ealbd to the rendering unit 33-4 and the evaluation unit 37. The shape information generation unit 33-3 transmits the generated estimated shape information Enorm to the rendering unit 33-4 and the evaluation unit 37.

The rendering unit 33-4 generates the low-resolution relit image Eim_low based on the teacher lighting environment information Lrel, the estimated reflectance information Ealbd, and the estimated shape information Enorm (S54). The rendering unit 33-4 transmits the generated low-resolution relit image Eim_low to the mapping unit 34.

The mapping unit 34 generates the vectors w_low based on the low-resolution relit image Eim_low (S55). The mapping unit 34 transmits the generated vectors w_low to the generation unit 35.

The generation unit 35 generates the feature value group Ef_B based on the vectors w_low (S56). The generation unit 35 transmits the generated feature value group Ef_B to the feature correction unit 36.

The feature correction unit 36 generates the estimated relit images Eim and Eim_B based on the feature value groups Ef_A and Ef_B (S57). The feature correction unit 36 transmits the generated estimated relit images Eim and Eim_B to the evaluation unit 37.

The evaluation unit 37 updates the parameter P based on the estimated relit images Eim and Eim_B, the estimated reflectance information Ealbd, the estimated shape information Enorm, the teacher image Lim, the input reflectance information Ialbd, and the input shape information Inorm (358).

As described above, the learning operation using one of the learning data sets 18 ends (End).

In the example of FIG. 9, a case where the processing of S51 is executed before the processing between S52 and S56 has been described, but the present invention is not limited thereto. For example, the processing of S51 may be executed after the processing between S52 and S56. Further, the processing of S51 may be executed in parallel with the processing between S52 and S56.

### 1.4.2 Image Generation Operation

The image generation operation of the information processing system according to the embodiment will be described hereinbelow.

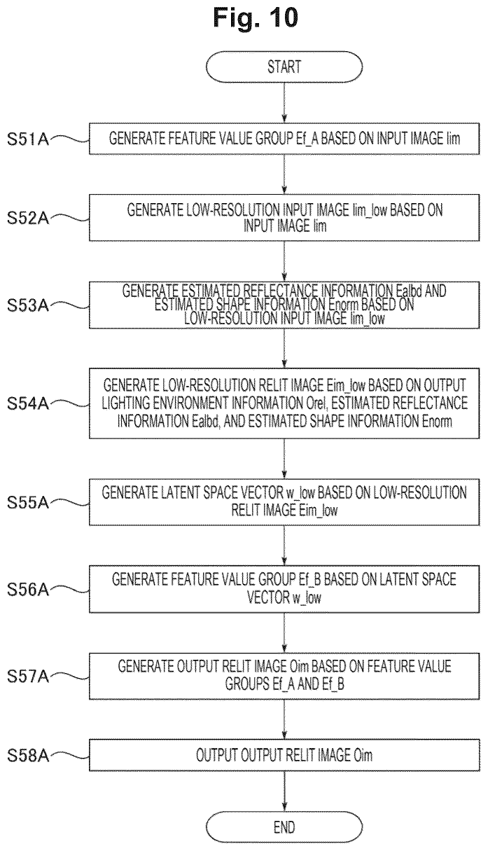

FIG. 10 is a flowchart illustrating one example of the image generation operation in the information processing device according to the embodiment.

When the image generation data set 19 is received from the transmission unit 17 (Start), the reception unit 31 transmits the input image Iim to the feature extraction unit 32 and the down-sampling unit 33-1. The reception unit 31 transmits the output lighting environment information Orel to the rendering unit 33-4.

The feature extraction unit 32 generates the feature value group Ef_A based on the input image Iim (S51A). The feature extraction unit 32 transmits the generated feature value group Ef_A to the feature correction unit 36.

The down-sampling unit 33-1 generates the low-resolution input image Iim_low based on the input image Iim (S52A). The down-sampling unit 33-1 transmits the generated low-resolution input image Iim_low to the reflectance information generation unit 33-2 and the shape information generation unit 33-3.

The reflectance information generation unit 33-2 and the shape information generation unit 33-3 generate the estimated reflectance information Ealbd and the estimated shape information Enorm, respectively, based on the low-resolution input image Iim_low (S53A). The reflectance information generation unit 33-2 transmits the generated estimated reflectance information Ealbd to the rendering unit 33-4. The shape information generation unit 33-3 transmits the generated estimated shape information Enorm to the rendering unit 33-4.

The rendering unit 33-4 generates the low-resolution relit image Eim_low based on the output lighting environment information Orel, the estimated reflectance information Ealbd, and the estimated shape information Enorm (S54A). The rendering unit 33-4 transmits the generated low-resolution relit image Eim_low to the mapping unit 34.

The mapping unit 34 generates the vectors w_low based on the low-resolution relit image Eim_low (S55A). The mapping unit 34 transmits the generated vectors w_low to the generation unit 35.

The generation unit 35 generates the feature value group Ef_B based on the vectors w_low (S56A). The generation unit 35 transmits the generated feature value group Ef_B to the feature correction unit 36.

The feature correction unit 36 generates an output relit image Oim based on the feature value groups Ef_A and Ef_B (S57A). The feature correction unit 36 transmits the generated output relit image Oim to the output unit 39.

The output unit 39 outputs the output relit image Oim to the user (S58A).

The image generation operation ends (End).

### 1.5 Advantageous Effects of Embodiment

According to the embodiment, the down-sampling unit 33-1 generates a low-resolution input image Iim_low having a lower resolution than the input image Iim based on the input image Iim. The reflectance information generation unit 33-2 and the shape information generation unit 33-3 estimate the estimated reflectance information Ealbd and the estimated shape information Enorm, respectively, based on the low-resolution input image Iim_low. The rendering unit 33-4 generates a low-resolution relit image Eim_low based on the estimated reflectance information Ealbd, the estimated shape information Enorm, and the teacher lighting environment information Lrel indicating a lighting environment different from the lighting environment of the input image Iim. Consequently, it is possible to suppress the load required for the reflectance and 3D shape estimation processing and the rendering processing as compared with a case where the inverse rendering is directly applied to the input image Iim.

The mapping unit 34 generates the vectors w_low representing the latent space based on the low-resolution relit image Eim_low. The generation unit 35 generates the estimated relit image Eim_B having a higher resolution than the low-resolution relit image Eim_low based on the vectors w_low. Accordingly, the resolution of the relit image can be adjusted to the same level as the input image Iim using the image generation model pre-trained with a large-scale dataset. Therefore, deteriorated image quality of the relit image can be prevented.

The estimated relit image Eim_B may not be able to reproduce a high-definition image structure in the input image Iim such as the hair tip and the eyes. According to the present embodiment, the feature extraction unit 32 extracts the feature value group Ef_A for the input image Iim. The feature correction unit 36 generates the output relit image Oim obtained by correcting the estimated relit image Eim_B based on the feature value group Ef_A and the feature value group Ef_B of the estimated relit image Eim_B. Therefore, features not included in the feature value group Ef_B can be corrected by the feature value group Ef_A based on the high-resolution input image Iim. In other words, even a high-definition portion of the image can be reproduced.

Each of the feature extraction unit 32, the reflectance information generation unit 33-2, the shape information generation unit 33-3, the mapping unit 34, and the feature correction unit 36 includes a neural network. Therefore, the parameter P of the neural network can be updated by the learning operation using, for example, the teacher image Lim.

Specifically, the evaluation unit 37 updates the parameter P based on the estimated relit images Eim and Eim_B, the estimated reflectance information Ealbd, and the estimated shape information Enorm. Accordingly, it is possible improve the image quality of the output relit image Oim.

The generation unit 35 also includes a neural network. However, the evaluation unit 37 does not update parameters of the neural network in the generation unit 35. The existing image generation model can be thus used for the generation unit 35. It is possible to save time and effort of parameter update in the generation unit 35.

### 2. Others

Various modifications can be made in the embodiment stated above.

For example, in the embodiment stated above, a case where the programs for executing the learning operation and the image generation operation are executed by the storage device 100 and the information processing device 200 in the information processing system 1 has been described, but the present invention is not limited thereto. For example, the programs for executing the learning operation and the image generation operation may be executed on a calculation resource on the cloud.

The present invention is not limited to the embodiments described above, and various modifications can be made without departing from the scope of the invention. Each embodiment may be implemented in appropriate combination leading to combined effects. Furthermore, the embodiments described above include various inventions, and various inventions can be extracted by a combination selected from a plurality of disclosed components. For example, even if some components are eliminated from all the components described in the embodiment, in a case where the problem can be solved and the advantageous effects can be obtained, a configuration from which the components are eliminated can be extracted as an invention.

### REFERENCE SIGNS LIST

1 Information processing system
11, 21 Control circuit
12, 22 Storage
13, 23 Communication module
14, 24 Interface
15, 25 Drive
15m, 25m Storage medium
16 Preprocessing unit
17 Transmission unit
18 A plurality of learning data sets
19 Image generation data set
31 Reception unit
32 Feature extraction unit
33 Inverse rendering unit
33-1 Down-sampling unit
33-2 Reflectance information generation unit
33-3 Shape information generation unit
33-4 Rendering unit
34 Mapping unit
35 Generation unit
36 Feature correction unit
37 Evaluation unit
38 Learning model
39 Output unit
100 Storage device
200 Information processing device

1. An information processing device, comprising:
extraction circuitry configured to extract a first feature value of a first image;
inverse rendering circuitry configured to generate a second image having a resolution lower than that of the first image based on the first image and first information indicating a lighting environment different from that of the first image;
mapping circuitry configured to generate a vector representing a latent space based on the second image;
generation circuitry configured to generate a second feature value of a third image having a resolution higher than that of the second image based on the vector; and
correction circuitry configured to generate a fourth image obtained by correcting the third image based on the first feature value and the second feature value.

2. The information processing device according to claim 1, wherein the inverse rendering circuitry is configured to include:
a down-sampling circuitry configured to generate a fifth image having a resolution lower than that of the first image based on the first image;
an estimation circuitry configured to estimate, based on the fifth image, second information indicating a reflectance of the fifth image and third information indicating a 3D shape of the fifth image; and
a rendering circuitry configured to generate the second image based on the first information, the second information, and the third information.

3. The information processing device according to claim 2, wherein:
each of the extraction circuitry, the estimation circuitry, the mapping circuitry, the generation circuitry, and the correction circuitry includes a neural network.

4. The information processing device according claim 3, further comprising:
an evaluation circuitry configured to update parameters of the neural network in each of the extraction circuitry, the estimation circuitry, the mapping circuitry, and the correction circuitry, on the basis of the second image, the third image, the second information, and the third information.

5. The information processing device according to claim 4, wherein:
the evaluation circuitry is configured not to update a parameter of the neural network in the generation circuitry.

6. An information processing method, comprising:
extracting a first feature value of a first image;
generating a second image having a resolution lower than that of the first image based on the first image and first information indicating a lighting environment different from that of the first image;
generating a vector representing a latent space based on the second image;
generating a second feature value of a third image having a resolution higher than that of the second image based on the vector; and
generating a fourth image obtained by correcting the third image based on the first feature value and the second feature value.

7. The information processing method according to claim 6, wherein the generating the second image includes:
generating a fifth image having a resolution lower than that of the first image based on the first image;
estimating, based on the fifth image, second information indicating a reflectance of the fifth image and third information indicating a 3D shape of the fifth image; and
generating the second image based on the first information, the second information, and the third information, and
the method further comprising:
updating parameters used in each of the extracting, the estimating, the generating the vector, and the generating the fifth image, on the basis of the fourth image, the fifth image, the first information, and the second information.

8. A non-transitory computer readable medium storing a program causing a computer to function as each circuitry included in the information processing device according to claim 1.

9. A non-transitory computer readable medium storing a program causing a computer to perform the method of claim 6.
